(19) United States
(12) Patent Application Publication
(10) Pub. No.: US 2024/0250316 A1
(43) Pub. Date: Jul. 25, 2024

(54) BATTERY

(71) Applicant: Panasonic Intellectual Property Management Co., Ltd., Osaka (JP)

(72) Inventor: EIICHI KOGA, Hokkaido (JP)

(21) Appl. No.: 18/628,707

(22) Filed: Apr. 6, 2024

Related U.S. Application Data
(63) Continuation of application No. PCT/JP2022/027347, filed on Jul. 12, 2022.

(30) Foreign Application Priority Data
Oct. 26, 2021 (JP) 2021-174984

(51) Int. Cl. H01M 10/42; H01M 10/0562; H01M 10/0585

(52) U.S. Cl. CPC H01M 10/4235; H01M 10/0562; H01M 10/0585; H01M 2300/0068

(57) ABSTRACT

A battery includes a first electrode layer, a first solid electrolyte layer, a second electrode layer, and a stress relaxation layer in this order. The first solid electrolyte layer contains a first solid electrolyte material. The stress relaxation layer satisfies at least one selected from the group consisting of (A) and (B): (A) the stress relaxation layer is thicker than the first solid electrolyte layer; and (B) the stress relaxation layer is softer than the first solid electrolyte layer. The stress relaxation layer is substantially non-electron conductive.

### BACKGROUND

### 1. Technical Field

The present disclosure relates to a battery.

### 2. Description of the Related Art

International Publication No. 2019/189311 discloses an all-solid-state battery including a positive electrode current collector layer, a positive electrode active material layer, a negative electrode current collector layer, a negative electrode active material layer, and a solid electrolyte layer located between the positive electrode active material layer and the negative electrode active material layer.

### SUMMARY

One non-limiting and exemplary embodiment provides a battery having improved reliability.

In one general aspect, the techniques disclosed here feature a battery including a first electrode layer; a first solid electrolyte layer; a second electrode layer; and a stress relaxation layer in this order, wherein the first solid electrolyte layer contains a first solid electrolyte material, the stress relaxation layer satisfies at least one selected from the group consisting of (A) and (B): (A) the stress relaxation layer is thicker than the first solid electrolyte layer; (B) the stress relaxation layer is softer than the first solid electrolyte layer, and the stress relaxation layer is substantially non-electron conductive.

The present disclosure provides a battery having improved reliability.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 illustrates a cross-sectional view and a plan view each illustrating a schematic configuration of a battery according to a first embodiment;

FIG. 2 illustrates a cross-sectional view and a plan view each illustrating a schematic configuration of a battery according to a second embodiment;

FIG. 3 illustrates a cross-sectional view and a plan view each illustrating a schematic configuration of a battery according to a third embodiment;

FIG. 4 illustrates a cross-sectional view and a plan view each illustrating a schematic configuration of a battery according to a fourth embodiment;

FIG. 5 illustrates a cross-sectional view and a plan view each illustrating a schematic configuration of a battery according to a fifth embodiment;

FIG. 6 illustrates a cross-sectional view and a plan view each illustrating a schematic configuration of a battery according to a sixth embodiment;

FIG. 7 illustrates a cross-sectional view and a plan view each illustrating a schematic configuration of a battery according to a seventh embodiment;

FIG. 8 illustrates a cross-sectional view and a plan view each illustrating a schematic configuration of a battery according to an eighth embodiment; and

FIG. 9 illustrates a cross-sectional view and a plan view each illustrating a schematic configuration of a battery according to a ninth embodiment.

### DETAILED DESCRIPTIONS

Hereinafter, embodiments of the present disclosure will be described in detail with reference to the drawings.

The embodiments described below are all general or specific examples. The numbers, shapes, materials, components, positions of the components, and connections between the components in the following embodiments are examples and should not be construed as limiting of the disclosure.

In this specification, terms indicating relationships between components such as parallel, terms indicating shapes of components such as rectangular, and numerical ranges are not strictly limited to the meanings of the terms and the ranges. The terms and the ranges may include approximation, such as variations of a few percents.

The drawings are schematic views and are not necessarily accurate. Accordingly, in the drawings, components are not necessarily to scale. In the drawings, the same reference numerals are assigned to the components having substantially the same configuration without duplicated or detailed explanation.

In the specification and the drawings, the x, y, and z axes are three axes of a three-dimensional orthogonal coordinate system. In the embodiments, the z direction corresponds to the thickness direction of the battery. In the specification, the “thickness direction” is a direction perpendicular to the plane on which the laminated body of the battery layers is disposed, unless otherwise specified.

In the specification, when the battery is viewed in “plan view”, the battery is viewed in the laminating direction of layers, unless otherwise specified. In this specification, the “thickness” refers to a dimension of the battery and the layers of the battery in the laminating direction, unless otherwise specified.

In this specification, “side surfaces” of the battery and the layers of the battery refer to surfaces of the battery and the layers extending in the laminating direction, and “main surfaces” refer to surfaces other than the side surfaces, unless otherwise specified.

In this specification, when the battery is viewed in the laminating direction, “inner” of “inner side” refers to a central side of the battery, and “outer” of “outer side” refers to an outer peripheral side of the battery, for example.

In the specification, the terms “upper” and “lower” used to describe the configuration of the battery are not meant to refer to the upward direction (vertically upward) and the downward direction (vertically downward) in absolute spatial awareness. The terms are meant to refer to the relative positional relationship in the laminated body based on the laminating order. Furthermore, the terms “upper” and “lower” are used not only for a case where two components are spaced apart from each other with another component being interposed therebetween but also for a case where two adjacent components are in contact with each other.

### First Embodiment

Hereinafter, a battery according to a first embodiment will be described.

The battery according to the first embodiment includes a first electrode layer, a first solid electrolyte layer, a second electrode layer, and a stress relaxation layer in this order. Hereafter, a laminated body including a first electrode layer, a first solid electrolyte layer, and a second electrode layer may be referred to as a battery element.

The first solid electrolyte layer contains a first solid electrolyte material.

The stress relaxation layer is substantially non-electron conductive. The stress relaxation layer satisfies at least one selected from the group consisting of (A) and (B): (A) the stress relaxation layer is thicker than the first solid electrolyte layer; and (B) the stress relaxation layer is softer than the first solid electrolyte layer.

In this specification, “the stress relaxation layer is substantially non-electron conductive” means that the electron conductivity of the stress relaxation layer is less than or equal to 10 μS/m, and the electron conductivity may be less than or equal to 1 μS/m. The stress relaxation layer may be non-electron conductive. The stress relaxation layer may be an insulating layer formed of an insulating material.

A battery having the above configuration can have excellent characteristics and high reliability. The characteristics include, for example, a capacity and an energy density.

A thinner first solid electrolyte layer and thicker first and second electrode layers may be used to improve the battery characteristics. Even in such a case, internal stresses generated by charging and discharging is absorbed and relieved by the stress relaxation layer having the above configuration. The internal stress generated by charging and discharging is an internal stress caused by the electrode layer expanded or shrunk by charging and discharging. The stress relaxation layer restrains elongation or shrinkage of the battery element, and thus delamination and cracking in the layers are reduced. Furthermore, in the laminating step of integrating the layers in the production process, the stress relaxation layer absorbs difference in compressibility between the first electrode layer and the second electrode layer and restrains the elongation of the first and second electrode layers in the plane direction. This reduces initial structural defects (e.g., deformation, warping, or cracking). As described above, the battery according to the first embodiment has less initial structural defects and less defects caused during charge-discharge cycles and thus has high reliability.

The stress relaxation layer may satisfy both (A) and (B). The stress relaxation layer having such a configuration can more effectively absorb and relieve the internal stresses in the battery caused by charging and discharging. Thus, the battery according to the first embodiment has more improved characteristics and improved reliability.

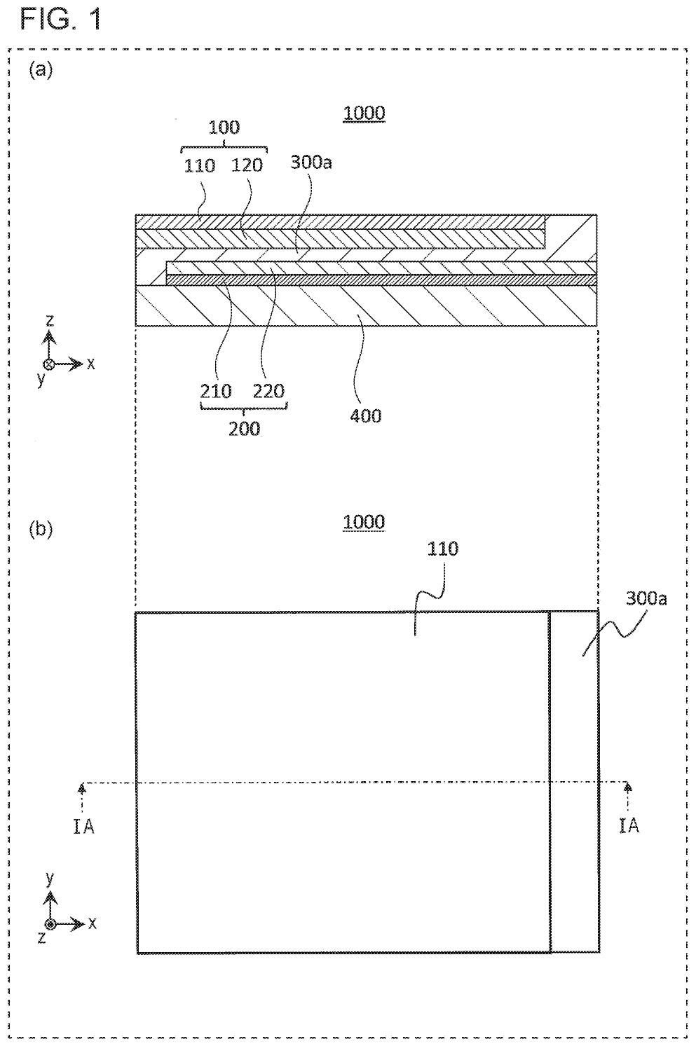

FIG. 1 illustrates a cross-sectional view and a plan view each illustrating a schematic configuration of a battery 1000 according to the first embodiment.

FIG. 1(a) is a cross-sectional view of the battery 1000 according to the first embodiment. FIG. 1(b) is a plan view of the battery 1000 viewed from above in the z direction. The cross section in FIG. 1(a) is taken along line IA-IA in FIG. 1(b).

As illustrated in FIG. 1, the battery 1000 includes a first electrode layer 100, a first solid electrolyte layer 300a, a second electrode layer 200, and a stress relaxation layer 400 in this order.

The first solid electrolyte layer 300a contains a first solid electrolyte material.

The stress relaxation layer 400 is substantially non-electron conductive. The stress relaxation layer 400 satisfies at least one selected from the group consisting of (A) and (B). In other words, the stress relaxation layer 400 is thicker than the first solid electrolyte layer 300a and/or softer than the first solid electrolyte layer 300a.

The battery 1000 having this configuration can have improved reliability.

The thickness of the first solid electrolyte layer 300a is the thickness of a portion of the first solid electrolyte layer 300a located between the first electrode layer 100 and the second electrode layer 200. The thickness of the stress relaxation layer 400 is the thickness of a portion that overlaps the second electrode layer 200 in plan view.

In this disclosure, the thickness of each layer may be the average of thicknesses measured by cross-sectional observation or CT scan at equally spaced five points in the plane. The equally spaced five points in the plane mean a total of five points including at least, in plan view of the layer to be measured, a central point and two peripheral points. For example, the thickness may be the average of thicknesses measured at a total of five points including, in plan view of the layer to be measured, a first point at the center, a second point at the peripheral portion, a third point at the peripheral portion opposite the second point with the first point therebetween, a fourth point between the first point and the second point, and a fifth point between the first point and the third point.

As described above, the stress relaxation layer 400 may be softer than the first solid electrolyte layer 300a. Here, the fact that the stress relaxation layer 400 is softer than the first solid electrolyte layer 300a can be confirmed, for example, by Vickers hardness test. A rigid indenter, like one used in Vickers hardness test, is pressed against the cross-sectional surface of the stress relaxation layer 400 and that of the first solid electrolyte layer 300a. The relative hardness, soft or hard, of the stress relaxation layer 400 and the hardness of the first solid electrolyte layer 300a is determined by the amount of the deformation, large or small. In the Vickers hardness test, large deformation means soft, and small deformation means hard. This enables determination whether the stress relaxation layer 400 is softer than the first solid electrolyte layer 300a. The cross-sectional surfaces of the stress relaxation layer 400 and the first solid electrolyte layer 300a used in determination of the flexibility are, for example, cross-sectional surfaces exposed by ion polishing or smooth mechanical polishing.

The battery 1000 is, for example, an all-solid-state battery.

The battery 1000 may be a primary or secondary battery.

The first electrode layer 100 includes, for example, a first current collector 110 and a first active material layer 120.

The second electrode layer 200 includes, for example, a second current collector 210 and a second active material layer 220.

The first solid electrolyte layer 300a is located between the first active material layer 120 and the second active material layer 220. The first solid electrolyte layer 300a may be in contact with both the first active material layer 120 and the second active material layer 220.

The first solid electrolyte layer 300a may cover the side surface of the first electrode layer 100, as illustrated in FIG. 1(a).

The first solid electrolyte layer 300a may cover the side surface of the second electrode layer 200, as illustrated in FIG. 1(a).

The stress relaxation layer 400 may be in contact with the second current collector 210.

When the stress relaxation layer 400 satisfies (A), the stress relaxation layer 400 may be at least twice as thick as the first solid electrolyte layer 300a to improve the reliability of the battery 1000. The stress relaxation layer 400 having such a configuration can absorb and reduce expansion, shrinkage, or compressive stress components of the electrode layer that cannot be absorbed by the first solid electrolyte layer 300a. The stress relaxation layer 400 also can more effectively restrain the deformation of the electrode layers and absorb deformation (e.g., elongation or shrinkage) in the planar direction of the electrode layers, which is caused during charging and discharging or integration through laminating. This enables the battery 1000 to have further improved reliability.

To improve the reliability of the battery 1000, the thickness of the stress relaxation layer 400 may be thicker than a total thickness of the first electrode layer 100, the first solid electrolyte layer 300a, and the second electrode layer 200. This enables the stress relaxation layer 400 to sufficiently absorb and restrain expansion, shrinkage, or elongation of the battery element caused by charging and discharging. Thus, the battery 1000 is further less likely to have structural defects, delamination, and warping of the layers.

The stress relaxation layer 400 may have a lower density than the first solid electrolyte layer 300a. This makes the stress relaxation layer 400 more deformable than the first solid electrolyte layer 300a. Thus, the stress relaxation layer 400 can absorb more stress. The densities of the first solid electrolyte layer 300a and the stress relaxation layer 400 are apparent densities. For example, the cross-sectional surface of the measurement-target layer is observed by using an image taken by a scanning electron microscope (SEM) to determine the area ratio between the material of the layer and the voids. By using the area ratio, the volume ratio between the material of the layer and the voids in the measurement-target layer is determined. This volume ratio and the true density (i.e., theoretical density) of the material of the measurement-target layer are used to determine the apparent density of the layer. The true density of the material of the measurement-target layer can be determined, for example, by the type of the material checked in advance and literature values of such a material, for example. Alternatively, when the composition and crystal structure of the material are known, the true density of the material of the measurement-target layer can be calculated. The crystal structure can be confirmed, for example, by determining the lattice constant by using XRD.

As illustrated in FIG. 1, the first solid electrolyte layer 300a may be continuous with the stress relaxation layer 400. In other words, the first solid electrolyte layer 300a may be in contact with the stress relaxation layer 400.

The stress relaxation layer 400 may contain a second solid electrolyte material. The stress relaxation layer 400 that contains the solid electrolyte material can have the physical properties (such as mechanical properties and thermal properties) similar to those of the first solid electrolyte layer 300a, which also contains the solid electrolyte material. This enables the first solid electrolyte layer 300a and the stress relaxation layer 400 to be integrated without defects at their interface, when the first solid electrolyte layer 300a and the stress relaxation layer 400 in contact with each other are subjected to pressure or heat treatment in the process of producing the battery 1000, for example.

When the stress relaxation layer 400 contains the second solid electrolyte material, the stress relaxation layer 400 may satisfy (A). In other words, the stress relaxation layer 400 may contain the second solid electrolyte material and may be thicker than the first solid electrolyte layer 300a.

The first current collector 110, the first active material layer 120, the first solid electrolyte layer 300a, the second active material layer 220, and the second current collector 210 each may have a substantially rectangular shape in plan view.

The first electrode layer 100 may be a positive electrode, and the second electrode layer 200 may be a negative electrode. In this case, the first current collector 110 is a positive electrode current collector, and the first active material layer 120 is a positive electrode active material layer. The second current collector 210 is a negative electrode current collector, and the second active material layer 220 is a negative electrode active material layer.

The first electrode layer 100 may be a negative electrode, and the second electrode layer 200 may be a positive electrode.

Of the positive electrode and the negative electrode, one that expands and shrinks more may be the second electrode layer 200. This makes it easier to mitigate influence of expansion and shrinkage of the second electrode layer 200 because the second electrode layer 200 is located close to the stress relaxation layer 400.

Hereinafter, the first current collector 110 and the second current collector 210 may be referred to collectively and simply as “current collectors”. The first active material layer 120 and the second active material layer 220 may be referred to collectively and simply as “active material layers”.

The specific configuration of the battery 1000 will be described below.

The current collectors only have to be formed of a conductive material. Examples of the material of the current collector include stainless steel, nickel (Ni), aluminum (Al), iron (Fe), titanium (Ti), copper (Cu), palladium (Pd), gold (Au), platinum (Pt), and an alloy of two or more of these. The materials in the form of foil, plate, or mesh may be used as the current collectors.

The material of the current collector may be selected in view of the manufacturing process, the operating temperature, the operating pressure, the battery operating potential applied to the collector, or the conductivity. The material of the current collector may be selected in view of the tensile strength or heat resistance required to the battery. The current collector may be a high-strength electrolytic copper foil or a clad material including laminated dissimilar metal foils.

The current collector may have a thickness of greater than or equal to 10 μm and less than or equal to 100 μm.

The surface of the current collector may be machined into a roughened uneven surface to enhance adhesion to the active material layer (the first active material layer 120 or the second active material layer 220).

The surface of the current collector may be coated with an adhesive such as an organic binder. This improves the connection between the current collector and the other layers. Thus, the mechanical reliability, thermal reliability, and cycling characteristics of the battery 1000 can be improved.

The first active material layer 120 is located between the first current collector 110 and the first solid electrolyte layer 300a. The first active material layer 120 may be in contact with the first current collector 110. The first active material layer 120 may cover the entire main surface of the first current collector 110.

The positive electrode active material layer (e.g., the first active material layer 120) contains a positive electrode active material.

In the positive electrode active material, metal ions such as lithium (Li) ions and magnesium (Mg) ions are inserted into or removed from the crystal structure at a higher potential than in the negative electrode, and the material is oxidized or reduced accordingly.

The positive electrode active material may be a compound containing lithium and a transition metal element. Examples of the compound include an oxide that contains lithium and a transition metal element and a phosphate compound that contains lithium and a transition metal element.

Examples of the oxide that contains lithium and a transition metal element include lithium nickel composite oxides such as LiNiₓM₁₋ₓO₂ (where M is at least one selected from the group consisting of Co, Al, Mn, V, Cr, Mg, Ca, Ti, Zr, Nb, Mo, and W, and x satisfies 0<x≤1), layered oxides such as lithium cobalt oxide (LiCoO₂), and lithium nickel oxide (LiNiO₂), and lithium manganese oxides having a spinel structure (such as LiMn₂O₄, LizMnO₃, and LiMnO₂).

An example of the phosphate compound containing lithium and a transition metal element is lithium iron phosphate (LiFePO₄) having an olivine structure.

As the positive electrode active material, sulfur (S) and sulfides such as lithium sulfide (Li₂S) may be used. In this case, the positive electrode active material particles coated with or having lithium niobate (LiNbO₃) or the like may be used as the positive electrode active material.

As the positive electrode active material, one of the above materials may be solely used, or two or more of the above materials may be used in combination.

To improve lithium-ion conductivity or electron conductivity, the positive electrode active material layer may contain a material other than the positive electrode active material, in addition to the positive electrode active material. In other words, the positive electrode active material layer may be a composite layer. Examples of such a material include inorganic solid electrolytes such as sulfide solid electrolytes, conductive aids such as acetylene black, and binders such as polyethylene oxide and polyvinylidene fluoride.

The first active material layer 120 may have a thickness of, for example, greater than or equal to 5 μm and less than or equal to 300 μm.

The second active material layer 220 is located between the second current collector 210 and the first solid electrolyte layer 300a. The second active material layer 220 may be in contact with the second current collector 210. The second active material layer 220 may cover the entire main surface of the second current collector 210.

The negative electrode active material layer (e.g., the second active material layer 220) contains a negative electrode active material.

In the negative electrode active material, metal ions such as lithium (Li) ions and magnesium (Mg) ions are inserted into or removed from the crystal structure at a lower potential than in the positive electrode, and the material is oxidized or reduced accordingly.

Examples of the negative electrode active material include carbon materials such as natural graphite, artificial graphite, graphite carbon fiber, and resin heat-treated carbon, and alloy-base materials that form a composite material with the solid electrolyte. Examples of the alloy-base materials include lithium alloys such as LiAl, LiZn, Li₃Bi, Li₃Cd, Li₃Sb, Li₄Si, Li_{4.4}Pb, Li_{4.4}Sn, Li_{0.17}C, and LiC₆, oxides of lithium and a transition metal element such as lithium titanate (Li₄Ti₅O₁₂), and metal oxides such as zinc oxide (ZnO) and silicon oxide (SiOx). As the negative electrode active material, one of the above materials may be solely used, or two or more of the above materials may be used in combination.

To improve the lithium-ion conductivity or the electron conductivity, the negative electrode active material layer may contain, in addition to the negative electrode active material, a material other than the negative electrode active material. Examples of such a material include inorganic solid electrolytes such as sulfide solid electrolytes, conductive aids such as acetylene black, and binders such as polyethylene oxide and polyvinylidene fluoride.

The second active material layer 220 may have a thickness of, for example, greater than or equal to 5 μm and less than or equal to 300 μm.

The first solid electrolyte layer 300a contains the first solid electrolyte material. The first solid electrolyte layer 300a contains, for example, the first solid electrolyte material as a main component. Herein, the main component means a component most abundant by mass in the first solid electrolyte layer 300a. The first solid electrolyte layer 300a may consist solely of the first solid electrolyte material.

The stress relaxation layer 400 is formed of a stress relaxation material. The stress relaxation material may satisfy at least one selected from the group consisting of (C) and (D): (C) difference in thermal shrinkage between the stress relaxation material and the first solid electrolyte material when heated at 200° C./h from room temperature (e.g., 25° C.) to 800° C., held at 800° ° C. for 2 hours, and cooled at 200° C./h to room temperature (e.g., 25° C.) is greater than or equal to −15% and less than or equal to 15%; and (D) difference in compressibility between the stress relaxation material and the first solid electrolyte material when pressurized at a pressure of 300 MPa for 90 seconds at 50° C. is greater than or equal to −15% and less than or equal to 15%.

The thermal shrinkage of the stress relaxation material is the rate of volume change of the stress relaxation material before and after the heat treatment described in (C), which is determined by the following formula. The thermal shrinkage of the first solid electrolyte material and that of the second solid electrolyte material (described later) are determined by the same way.

$$Thermal Shrinkage of Stress Relaxation Material = 100 \times [ ( Volume of Stress Relaxation Material Before Heat Treatment ) - ( Volume of Stress Relaxation Material After Heat Treatment ) \} / ( Volume of Stress Relaxation Material Before Heat Treatment )$$

The compressibility of the stress relaxation material is the rate of volume change of the stress relaxation material before and after the above pressurization described in (D), which is determined by the following formula. The compressibility of the first solid electrolyte material and that of the second solid electrolyte material (described later) are determined by the same way.

$$Compressibility of Stress Relaxation Material = 100 \times \{ ( Volume of Stress Relaxation Material Before Pressurization ) - ( Volume of Stress Relaxation Material After Pressurization ) \} \text{} / ( Volume of Stress Relaxation Material Before Pressurization )$$

When the stress relaxation material forming the stress relaxation layer 400 satisfies (C) and/or (D), the stress relaxation material and the first solid electrolyte material have similar thermal shrinkage characteristics in the above temperature range and/or similar compression characteristics under the above pressurization conditions. This enables the first solid electrolyte layer 300a and the stress relaxation layer 400 in contact with each other to be integrated without defects at their interface, when the first solid electrolyte layer 300a and the stress relaxation layer 400 are subjected to pressure or heat treatment in the process of producing the battery 1000, for example. Thus, the battery 1000 can have further improved reliability.

The stress relaxation material that forms the stress relaxation layer 400 may be, for example, a material that is substantially non-electron conductive, such as an insulating material. The stress relaxation material may be an inorganic material or a resin material. Examples of the inorganic material include oxides such as alumina, magnesia, and titania, and nitrides such as silicon nitride. Examples of the resin material include epoxy and silicone-based resin. The stress relaxation layer 400 may include both the inorganic material and the resin material.

As described above, the stress relaxation layer 400 may contain the second solid electrolyte material. The stress relaxation layer 400 may contain, for example, the second solid electrolyte material as a major component. Herein, the main component means a component most abundant by mass in the stress relaxation layer 400. The stress relaxation layer 400 may consist solely of the second solid electrolyte material. That is, the above stress relaxation material forming the stress relaxation layer 400 may contain the second solid electrolyte material, may contain the second solid electrolyte material as a major component, or may consist solely of the second solid electrolyte material.

When the stress relaxation layer 400 contains the second solid electrolyte material, the first solid electrolyte layer 300a and the stress relaxation layer 400 in contact with each other can be integrated without defects at the interface as described above. Thus, the battery 1000 can have further improved reliability.

The second solid electrolyte material may satisfy at least one selected from the group consisting of (E) and (F): (E) difference in thermal shrinkage between the second solid electrolyte material and the first solid electrolyte material when heated at 200° C./h from room temperature (e.g., 25° C.) to 800° C., held at 800° C. for 2 hours, and cooled at 200° C./h to room temperature (e.g., 25° C.) is greater than or equal to −15% and less than or equal to 15%; and (F) difference in compressibility between the second solid electrolyte material and the first solid electrolyte material when pressurized at a pressure of 300 MPa at 50° C. for 90 seconds is greater than or equal to −15% and less than or equal to 15%.

When the second solid electrolyte material forming the stress relaxation layer 400 satisfies (E) and/or (F), the solid electrolyte material and the first solid electrolyte material have similar thermal shrinkage characteristics in the above temperature range and/or similar compression characteristics under the above pressurization conditions. This enables the first solid electrolyte layer 300a and the stress relaxation layer 400 in contact with each other to be integrated without defects at their interface, when the first solid electrolyte layer 300a and the stress relaxation layer 400 are subjected to pressure or heat treatment in the process of producing the battery 1000, for example. Thus, the battery 1000 can have further improved reliability.

The first solid electrolyte material may have the same composition as the second solid electrolyte material. In this configuration, the first solid electrolyte material and the second solid electrolyte material have the same coefficient of thermal expansion and the same mechanical properties, and thus structural defects caused by temperature cycling such as thermal shock or structural defects caused under stress in the laminating process can be readily reduced. Furthermore, this eliminates the use of multiple solid electrolytes having different compositions, resulting in improved productivity.

The first solid electrolyte material may have a different composition than the second solid electrolyte material. This enables the compressibility to be widely controlled by varying the combinations of materials. Thus, expansion and shrinkage due to charge-discharge cycles and stress due to differences in compressibility between the first electrode layer 100 and the second electrode layer 200 are readily absorbed by the first and second solid electrolyte materials. Thus, defects in the battery 1000 can be reduced. The multilayer battery having this configuration can have excellent characteristics and high reliability.

The solid electrolyte material may be any known solid electrolyte for batteries that has ion conductivity. The solid electrolyte material may be a solid electrolyte that conducts metal ions such as lithium-ions and magnesium-ions. The first and second solid electrolyte materials are, for example, solid electrolytes having lithium-ion conductivity.

Examples of the solid electrolyte material include inorganic solid electrolytes such as sulfide solid electrolytes and oxide solid electrolytes.

Examples of the sulfide solid electrolytes include Li₂S—P₂S₅ solid electrolytes, LizS-SiS₂ solid electrolytes, Li₂S—B₂S₃ solid electrolytes, LizS-GeS₂ solid electrolytes, LizS-SiS₂—LiI solid electrolytes, LizS-SiS₂—Li₃PO₄ solid electrolytes, LizS-Ge₂S₂ solid electrolytes, Li₂S—GeS₂—P₂S₅ solid electrolytes, and Li₂S—GeS₂—ZnS solid electrolytes.

Examples of the oxide solid electrolytes include lithium-containing metal oxides, lithium-containing metal nitrides, lithium phosphate (Li₃PO₄), and lithium-containing transition metal oxides. Examples of the lithium-containing metal oxides include LizO-SiO₂ and Li₂O—SiO₂—P₂O₅. An example of lithium-containing metal nitrides is LiₓP_{y}O_{1-z}N_{z} (0<z≤1). An example of the lithium-containing transition metal oxide is lithium titanium oxide.

As a solid electrolyte material, one of the above materials may be solely used, or two or more of the above materials may be used in combination.

The second solid electrolyte material may be a sulfide solid electrolyte to improve the reliability of the battery 1000. The second solid electrolyte material may be Li₂S—P₂S₅. This makes it easier for the stress relaxation layer 400 to absorb and reduce the expansion and shrinkage of the electrode.

The solid electrolyte layer may contain a binder such as polyethylene oxide and polyvinylidene fluoride in addition to the solid electrolyte material.

The first solid electrolyte layer 300a may have a thickness of, for example, greater than or equal to 5 μm and less than or equal to 300 μm.

The stress relaxation layer 400 may have a thickness of, for example, greater than or equal to 5 μm and less than or equal to 300 μm.

The first solid electrolyte material and the second solid electrolyte material may consist of an agglomeration of particles or may have a sintered structure.

### Second Embodiment

Hereinafter, a second embodiment will be described. Description of the features described in the above first embodiment will be omitted as appropriate.

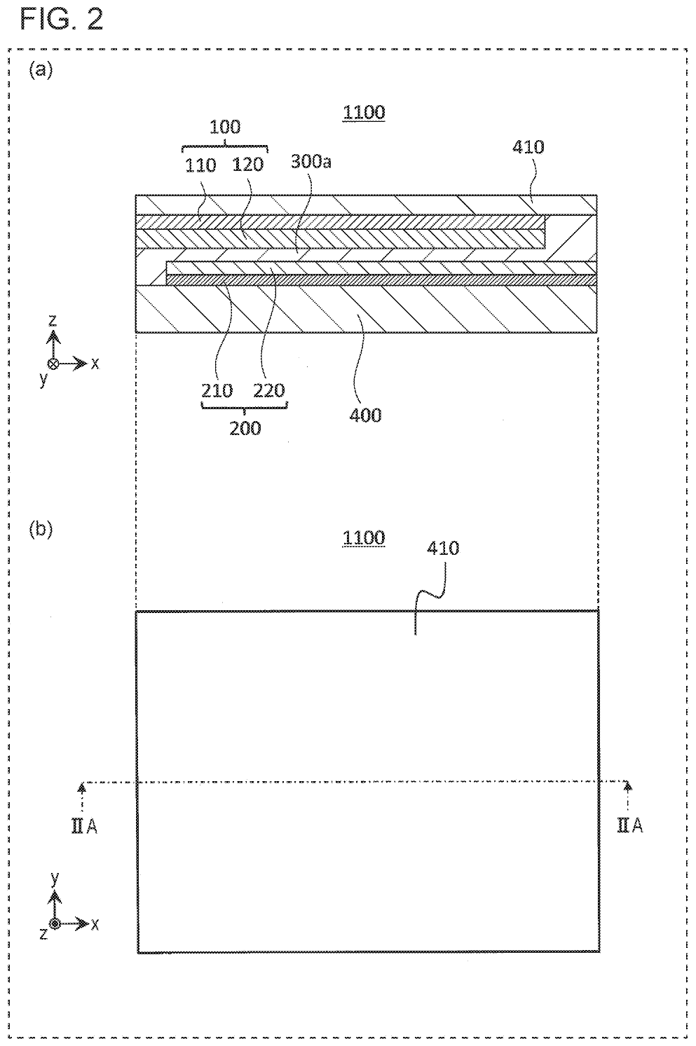

FIG. 2 illustrates a cross-sectional view and a plan view each illustrating a schematic configuration of a battery 1100 according to the second embodiment.

FIG. 2(a) is a cross-sectional view of the battery 1100 according to the second embodiment. FIG. 2(b) is a plan view of the battery 1100 according to the second embodiment viewed from above in the z direction. The cross-section in FIG. 2(a) is taken along line IIA-IIA in FIG. 2(b).

As illustrated in FIG. 2, the battery 1100 further includes a cover layer 410 in addition to the components of the battery 1000 according to the first embodiment. The cover layer 410 is in contact with the first electrode layer 100. The first electrode layer 100 is located between the first solid electrolyte layer 300a and the cover layer 410.

With this configuration, the battery 1100 can have mechanical reliability against warping and bending and weather resistance against moisture. Thus, the battery 1100 can have improved reliability.

The cover layer 410 may be formed of a solid electrolyte material. The solid electrolyte material may be one of the solid electrolytes listed as the examples of the solid electrolyte material in the first embodiment. The cover layer 410 may be formed of the same material as the first solid electrolyte material.

The cover layer 410 may be formed of an insulating material. Examples of the insulating material include an inorganic material and a resin material. Examples of the inorganic material include oxides such as alumina, magnesia, and titania, and nitrides such as silicon nitride. Examples of the resin material include epoxy and silicone-based resin. The cover layer 410 may contain both the inorganic material and the resin material.

The cover layer 410 may include multiple layers formed of insulating materials.

The cover layer 410 may be a rigid plate. In other words, a rigid plate may be bonded to the first electrode layer 100. The rigid plate is hard and thus can improve warpage protection and anti-fracture strength.

The shape of the cover layer 410 such as curve may be controlled by varying the material, mixing ratio of materials, or structure (such as thickness and number of layers) of the cover layer 410.

The cover layer 410 only has to cover, for example, at least a portion of the surface of the first electrode layer 100. The thickness and size of the cover layer 410 may be set appropriately, in view of the mechanical reliability and other factors.

### Third Embodiment

Hereinafter, a third embodiment will be described. Description of the features described in the above embodiments will be omitted as appropriate.

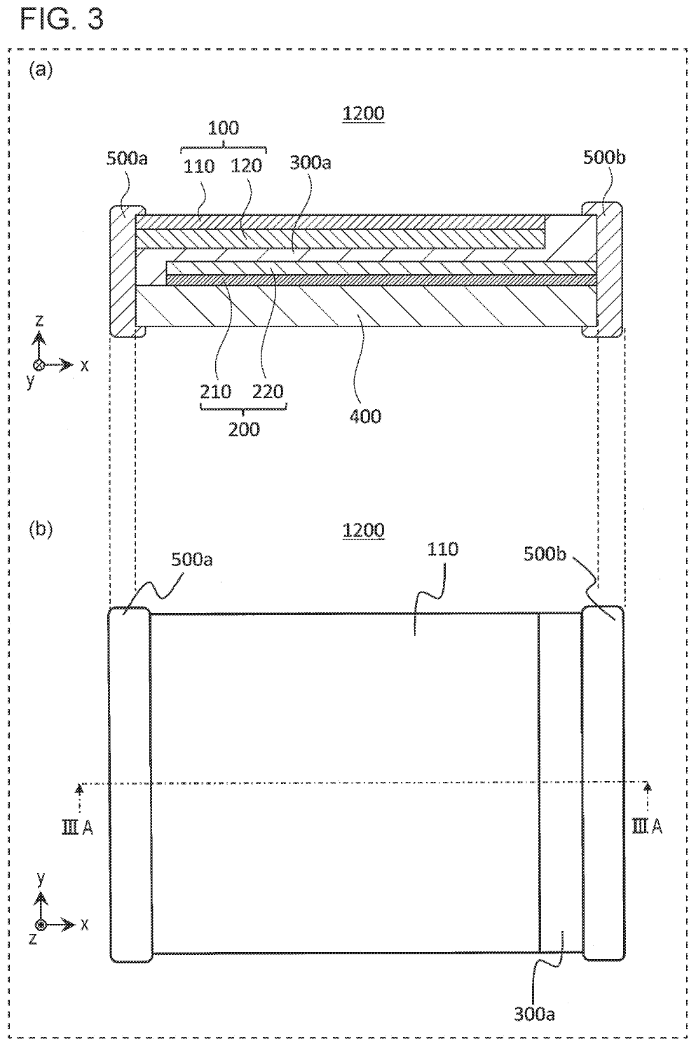

FIG. 3 illustrates a cross-sectional view and a plan view each illustrating a schematic configuration of a battery 1200 according to the third embodiment.

FIG. 3(a) is a cross-sectional view of the battery 1200 according to the third embodiment. FIG. 3(b) is a plan view of the battery 1200 according to the third embodiment viewed from above in the z direction. The cross section in FIG. 3(a) is taken along line IIIA-IIIA in FIG. 3(b).

As illustrated in FIG. 3, the battery 1200 further includes terminal electrodes 500a and 500b in addition to the components of the battery 1000 according to the first embodiment.

The terminal electrode 500a is electrically coupled to the first electrode layer 100. Specifically, the terminal electrode 500a is electrically coupled to the first current collector 110.

The terminal electrode 500b is electrically coupled to the second electrode layer 200. Specifically, the terminal electrode 500b is electrically coupled to the second current collector 210.

The battery 1200 having the terminal electrodes 500a and 500b can be used as a surface mount component. The battery 1200 can be mounted directly on a board without a lead terminal or other lead-out lines.

### Fourth Embodiment

Hereinafter, a fourth embodiment will be described. Description of the features described in the above embodiments will be omitted as appropriate.

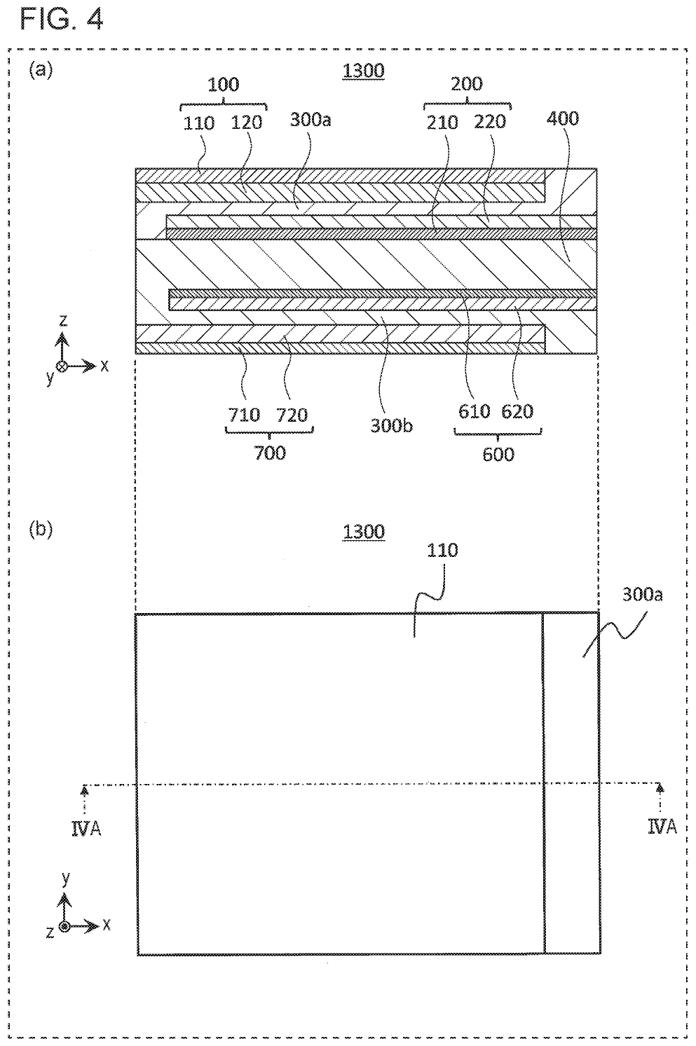

FIG. 4 illustrates a cross-sectional view and a plan view each illustrating a schematic configuration of a battery 1300 according to the fourth embodiment.

FIG. 4(a) is a cross-sectional view of the battery 1300 according to the fourth embodiment. FIG. 4(b) is a plan view of the battery 1300 according to the fourth embodiment viewed from above in the z direction. The cross section in FIG. 4(a) is taken along line IVA-IVA in FIG. 4(b).

As illustrated in FIG. 4, the battery 1300 includes a third electrode layer 600, a second solid electrolyte layer 300b, and a fourth electrode layer 700, in addition to the components of the battery 1000 according to the first embodiment.

The stress relaxation layer 400 is located between the second electrode layer 200 and the third electrode layer 600.

The third electrode layer 600 is located between the stress relaxation layer 400 and the second solid electrolyte layer 300b.

The second solid electrolyte layer 300b is located between the third electrode layer 600 and the fourth electrode layer 700.

The third electrode layer 600 has the same polarity as the second electrode layer 200. For example, the third electrode layer 600 and the second electrode layer 200 may both be negative electrodes.

The fourth electrode layer 700 has the same polarity as the first electrode layer 100. For example, both the fourth electrode layer 700 and the first electrode layer 100 may be positive electrodes.

The above configuration in which the second battery element (i.e., the third electrode layer 600, the second solid electrolyte layer 300b, and the fourth electrode layer 700) is connected in parallel with the first battery element (i.e., the first electrode layer 100, the first solid electrolyte layer 300a, and the second electrode layer 200) enables the battery having high reliability to have a larger capacity.

The stress relaxation layer 400 absorbs the stresses of expansion and shrinkage of the electrode layers caused by charging and discharging.

The second electrode layer 200 and the third electrode layer 600, which are located on the respective sides of the stress relaxation layer 400, have the same polarity, and thus have balanced stress against the stress relaxation layer 400 even when expanded or shrunk by charging and discharging, resulting in less warpage.

The third electrode layer 600 includes, for example, a third current collector 610 and a third active material layer 620.

The fourth electrode layer 700 includes, for example, a fourth current collector 710 and a fourth active material layer 720.

The second solid electrolyte layer 300b contains a third solid electrolyte material. The third solid electrolyte material may be one of the solid electrolytes listed as the examples of the solid electrolyte material in the first embodiment. The third solid electrolyte material may be the same as the first or second solid electrolyte material.

When the stress relaxation layer 400 contains the second solid electrolyte material, the second solid electrolyte material may have the same composition as the third solid electrolyte material. In this configuration, the second solid electrolyte material and the third solid electrolyte material have the same coefficient of thermal expansion and the same mechanical properties, and thus structural defects caused by temperature cycling such as thermal shock or structural defects caused under stress in the laminating process can be readily reduced. Furthermore, this eliminates the use of multiple solid electrolytes, resulting in improved productivity.

The stress relaxation layer 400 may have a lower density than the second solid electrolyte layer 300b. This makes the stress relaxation layer 400 more deformable than the second solid electrolyte layer 300b. This enables the second solid electrolyte layer 300b to absorb more stress.

The first solid electrolyte material, the second solid electrolyte material, and the third solid electrolyte material may have the same composition.

When the stress relaxation layer 400 contains the second solid electrolyte material, the second active material layer 220 and the third active material layer 620 may also contain the second solid electrolyte material. This allows the thermal expansion coefficients of the second active material layer 220 and the third active material layer 620 to be close to each other, reducing thermal stress. With this configuration, thermal stress can be reduced, and thus structural defects in the battery can be reduced, even if the battery has more layers and increases in size. In this way, the multilayer battery having a large capacity and a high energy density can have improved reliability.

The stress relaxation layer 400 may be thicker than the first solid electrolyte layer 300a and the second solid electrolyte layer 300b. In this configuration, the two battery elements are connected to each other with the stress relaxation layer 400 therebetween, and thus expansion and shrinkage caused by charge-discharge cycles can be absorbed by the stress relaxation layer 400. Thus, the battery can have a large capacity, high voltage, and high reliability.

The stress relaxation layer 400 may be at least twice as thick as the second solid electrolyte layer 300b to further improve the reliability of the battery 1000. The stress relaxation layer 400 can absorb and reduce the expansion, shrinkage, and compressive stress components of the multilayer battery element, which cannot be absorbed by the second solid electrolyte layer 300b. The stress relaxation layer 400 can also more effectively restrain the deformation of the electrode layers and absorb deformation (e.g., elongation or shrinkage) in the planar direction of the electrode layers, which is caused during charging and discharging or integration through laminating. Thus, the multilayer battery can have better properties and improved reliability.

The thickness of the stress relaxation layer 400 may be thicker than a total thickness of the third electrode layer 600, the second solid electrolyte layer 300b, and the fourth electrode layer 700. The stress relaxation layer 400 having such a configuration can absorb and restrain expansion, shrinkage, and elongation caused by charging and discharging of the multilayer battery element, resulting less structural defects (delamination or warpage).

The third electrode layer 600 may be electrically coupled to the second electrode layer 200. In this case, the second current collector 210 of the second electrode layer 200 and the third current collector 610 of the third electrode layer 600 are electrically coupled to each other, enabling the second electrode layer 200 and the third electrode layer 600 to function as a bipolar electrode as a whole. This configuration can form a series-connected battery by the use of the third electrode layer 600 and thus can provide a battery having high voltage and high reliability.

The third electrode layer 600 may be an equipotential electrode electrically coupled to the first electrode layer 100. This enables the third electrode layer 600 to form a repeated connection structure, and thus can provide a battery having a large capacity and high reliability.

### Fifth Embodiment

Hereinafter, a fifth embodiment will be described. Description of the features described in the above embodiments will be omitted as appropriate.

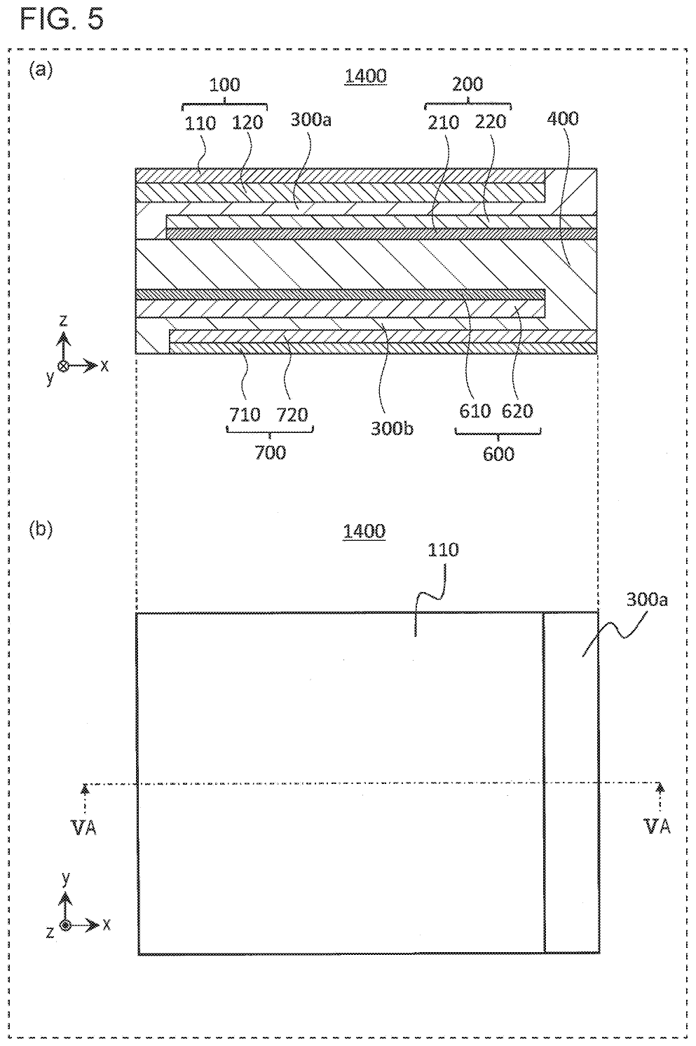

FIG. 5 illustrates a cross-sectional view and a plan view each illustrating a schematic configuration of a battery 1400 according to a fifth embodiment.

FIG. 5(a) is a cross-sectional view of the battery 1400 according to the fifth embodiment. FIG. 5(b) is a plan view of the battery 1400 according to the fifth embodiment viewed from above in the z direction. The cross section in FIG. 5(a) is taken along line VA-VA in FIG. 5(b).

As illustrated in FIG. 5, the battery 1400 includes a third electrode layer 600 and a fourth electrode layer 700, like the battery 1300 according to the fourth embodiment.

The third electrode layer 600 has a different polarity from the second electrode layer 200 and the same polarity as the first electrode layer 100. For example, the third electrode layer 600 and the first electrode layer 100 may both be positive electrodes.

The fourth electrode layer 700 has the same polarity as the second electrode layer 200. For example, the fourth electrode layer 700 and the second electrode layer 200 may both be negative electrodes.

The above configuration in which the second battery element (i.e., the third electrode layer 600, the second solid electrolyte layer 300b, and the fourth electrode layer 700) is connected in parallel with the first battery element (i.e., the first electrode layer 100, the first solid electrolyte layer 300a, and the second electrode layer 200) enables the battery having high reliability to have a larger capacity. As the battery 1400, the positive and negative electrodes may be alternately arranged (in the left-right direction in FIG. 5). This reduces and levels the differences in compressibility or elongation between the layers caused under stress of laminating. This reduces structural defects (delamination or deformation) caused during laminating, resulting in reduction in structural defects of the battery, which are likely to be caused in a multilayer structure including integrated multiple layers. Thus, the multilayer battery having a large capacity and a high energy density can have improved reliability.

The fourth electrode layer 700 may be eliminated from the battery 1400. The presence of the third electrode layer 600 can reduce warpage of the battery or elongation of the stress relaxation layer 400 (e.g., elongation under pressure) due to the restraining action of the third electrode layer 600, which is bonded to the stress relaxation layer 400. The second solid electrolyte layer 300b can absorb stress and deformation caused in series- or parallel-connected batteries. Thus, the battery having a large capacity and a high energy density can have improved reliability.

The stress relaxation layer 400 may be thicker than the second solid electrolyte layer 300b. In this configuration, the two battery elements are connected to each other with the stress relaxation layer 400 therebetween, and thus expansion and shrinkage caused by charge-discharge cycles can be absorbed by the stress relaxation layer 400. Thus, the battery can have a large capacity, high voltage, and high reliability.

The stress relaxation layer 400 may be at least twice as thick as the second solid electrolyte layer 300b to further improve the reliability of the battery. The stress relaxation layer 400 can absorb and reduce the expansion, shrinkage, and compressive stress components of the multilayer battery element, which cannot be absorbed by the second solid electrolyte layer 300b. The stress relaxation layer 400 can also more effectively restrain the deformation of the electrode layers and absorb deformation (e.g., elongation or shrinkage) in the planar direction of the electrode layers, which is caused during charging and discharging or integration through laminating. Thus, the multilayer battery can have better properties and improved reliability.

### Sixth Embodiment

Hereinafter, a sixth embodiment will be described. Description of the features described in the above embodiments will be omitted as appropriate.

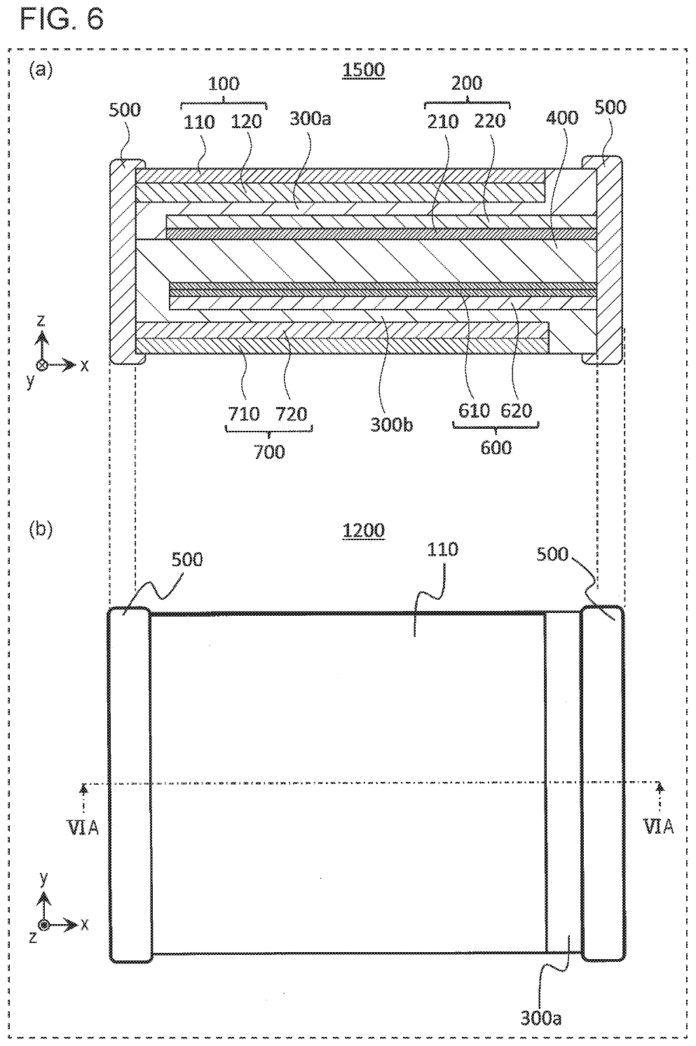

FIG. 6 illustrates a schematic configuration of a battery 1500 according to the sixth embodiment.

FIG. 6(a) is a cross-sectional view of the battery 1500 according to the sixth embodiment. FIG. 6(b) is a plan view of the battery 1500 according to the sixth embodiment viewed from above in the z direction. The cross section in FIG. 6(a) is taken along line VIA-VIA in FIG. 6(b).

As illustrated in FIG. 6, the battery 1500 includes a terminal electrode 500 in addition to the components of the battery 1300.

The above configuration enables the multilayer battery having a large capacity and a high energy density to be used as a surface mount component. The battery can be mounted directly on a board without a lead terminal or other lead-out lines.

### Seventh Embodiment

Hereinafter, a seventh embodiment will be described. Description of the features described in the above embodiments will be omitted as appropriate.

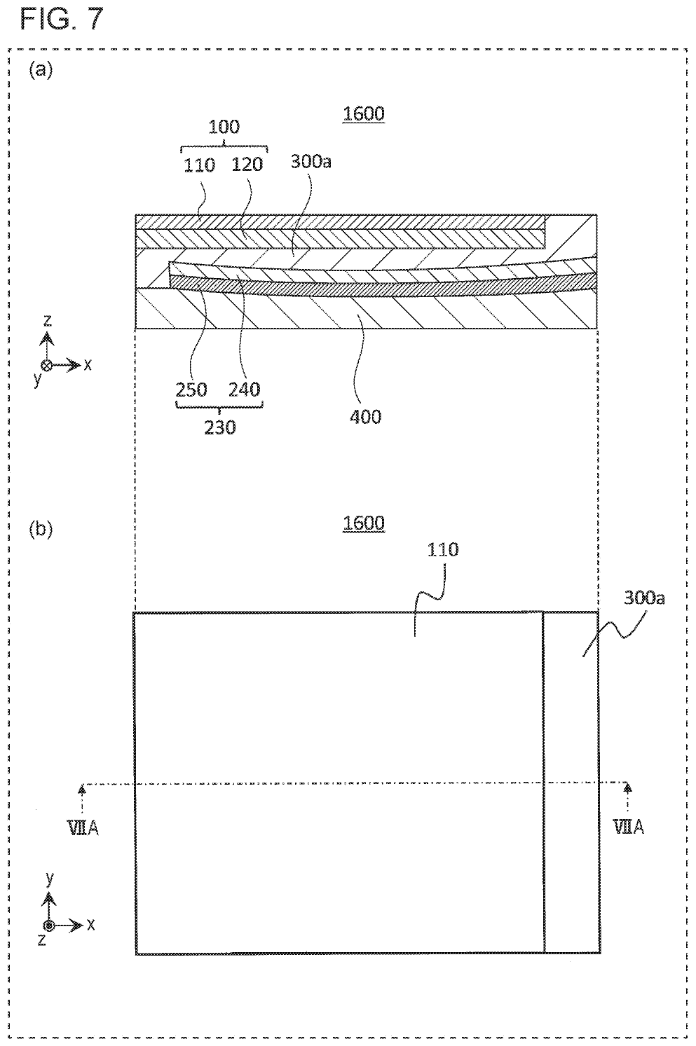

FIG. 7 illustrates a cross-sectional view and a plan view each illustrating a schematic configuration of a battery 1600 according to the seventh embodiment.

FIG. 7(a) is a cross-sectional view of the battery 1600 according to the seventh embodiment. FIG. 7(b) is a plan view of the battery 1600 according to the seventh embodiment viewed from above in the z direction. The cross section in FIG. 7(a) is taken along line VIIA-VIIA in FIG. 7(b).

As illustrated in FIG. 7, the battery 1600 differs from the battery 1000 in that the second electrode layer 230 curves convexly toward the stress relaxation layer 400.

In this configuration, the curved surface receives stresses of expansion, shrinkage, and elongation, and the stress components perpendicular to the interface or in the direction of sliding (direction along the interface) are distributed. Thus, delamination, which tends to occur at flat interfaces, is reduced. In other words, delamination of the layer in contact with the second electrode layer 230 is reduced. Thus, the battery can have high resistance to charge-discharge cycles and shocks and high reliability.

The second electrode layer 230 includes, for example, a second current collector 250 and a second active material layer 240.

For example, the curved second electrode layer 230 is formed by pressurizing a portion of the second electrode layer 230 (the second active material layer 240), which was printed by coating, with a curved die.

The second electrode layer 230 should be curved at a magnitude comparable to the thickness of the second electrode layer 230, for example, to have effects.

The thickness of the first solid electrolyte layer 300a may be the thickness measured between the surface of the first electrode layer 100 and the curved surface of the second electrode layer 230 opposed to each other.

The thickness of the layer may be the average of thicknesses measured by cross-sectional observation or CT scan at equally spaced five points in the plane.

If the battery 1600 includes the third electrode layer 600, like the batteries 1300 and 1400, the third electrode layer 600 may curve convexly in the same direction as the second electrode layer 200. The second electrode layer 200 may curve more than the third electrode layer 600. The magnitude of the curve is the distance between the apex of the curved portion and the end of the electrode layer in the thickness direction determined by using the cross-sectional view. In the cross-sectional view, the electrode layer has two ends. One of the ends that is farther away from the apex of the curved portion is used to determine the magnitude of the curve. The above-described configuration improves the bonding strength of the third electrode layer 600 and reduces structural defects such as delamination. Furthermore, the variation in the parallel relationship (state) of the upper and lower electrodes makes the structure more resistant to deformation, such as expansion and shrinkage. Thus, an assembled battery in which battery elements having less structural defects are connected can be formed, and thus the multi-layered battery can have excellent characteristics and high reliability.

### Eighth Embodiment

Hereinafter, an eighth embodiment will be described. Description of the features described in the above embodiments will be omitted as appropriate.

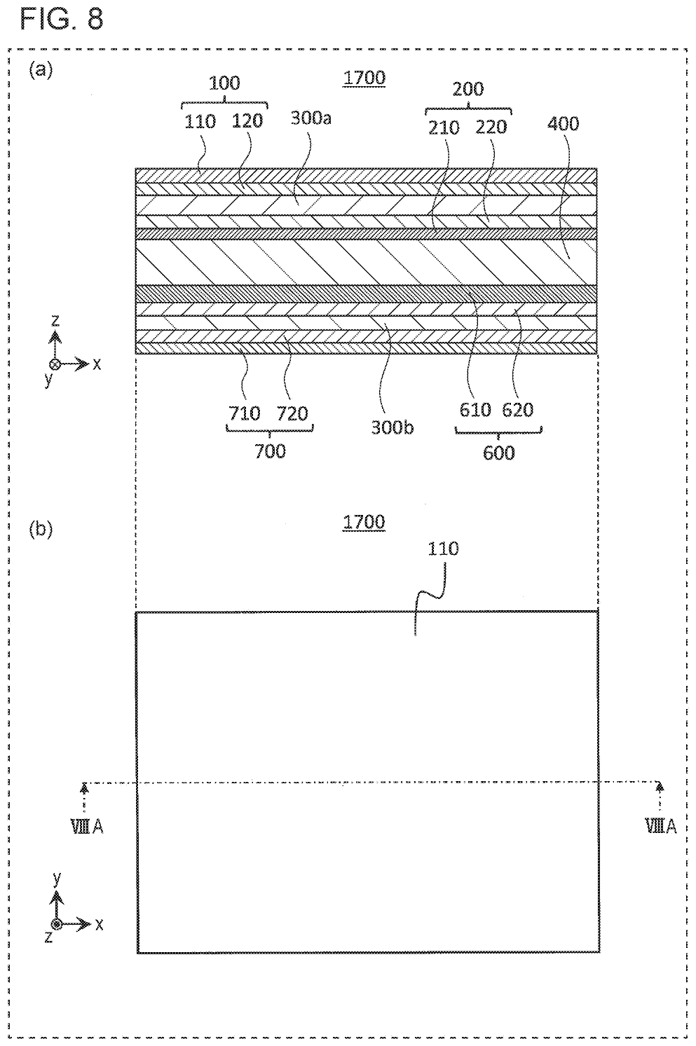

FIG. 8 illustrates a cross-sectional view and a plan view each illustrating a schematic configuration of a battery 1700 according to an eighth embodiment.

FIG. 8(a) is a cross-sectional view of the battery 1700 according to the eighth embodiment. FIG. 8(b) is a plan view of the battery 1700 according to the eighth embodiment viewed from above in the z direction. The cross section in FIG. 8(a) is taken along line VIIIA-VIIIA in FIG. 8(b).

As illustrated in FIG. 8, the battery 1700 includes the third electrode layer 600 and the fourth electrode layer 700, like the battery 1400 according to the fifth embodiment. However, the stress relaxation layer 400 is isolated by the second electrode layer 200 and the third electrode layer 600. In other words, the battery 1700 differs from the battery 1400 in that the stress relaxation layer 400 is not in contact with the first and second solid electrolyte layers 300a and 300b.

The third electrode layer 600 has a different polarity from the second electrode layer 200 and the same polarity as the first electrode layer 100. For example, the third electrode layer 600 and the first electrode layer 100 may both be positive electrodes.

The fourth electrode layer 700 has the same polarity as the second electrode layer 200. For example, the fourth electrode layer 700 and the second electrode layer 200 may both be negative electrodes.

The second electrode layer 200 and the third electrode layer 600 electrically coupled to each other by a lead terminal or the like can form an assembled battery including two battery elements connected in series.

The above configuration can provide a battery having a high voltage and high reliability.

### Ninth Embodiment

Hereinafter, a ninth embodiment will be described. Description of the features described in the above embodiments will be omitted as appropriate.

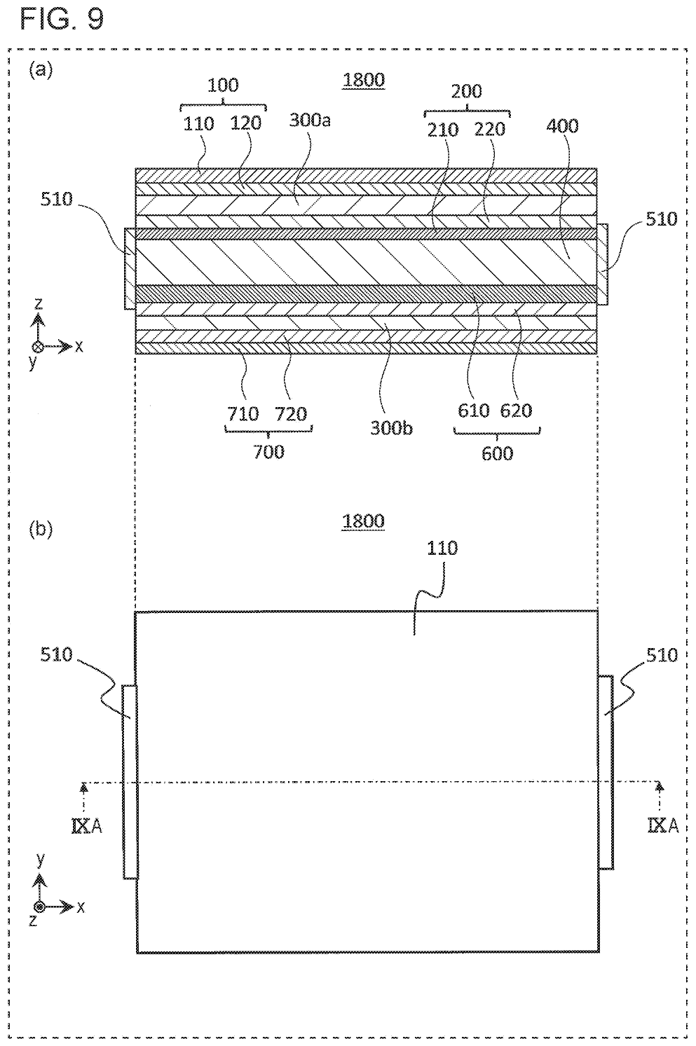

FIG. 9 illustrates a cross-sectional view and a plan view each illustrating a schematic configuration of a battery 1800 according to the ninth embodiment.

FIG. 9(a) is a cross-sectional view of the battery 1800 according to the ninth embodiment. FIG. 9(b) is a plan view of the battery 1800 according to the ninth embodiment viewed from above in the z direction. The cross section in FIG. 9(a) is taken along line IXA-IXA in FIG. 9(b).

As illustrated in FIG. 9, the battery 1800 includes terminal electrodes 510 in addition to the components of the battery 1700 according to the eighth embodiment.

The terminal electrodes 510 are in contact with the side surfaces of the battery 1800 and electrically coupled to the second electrode layer 200 and the third electrode layer 600.

In FIG. 9, the terminal electrodes 510 are disposed on the two opposing side surfaces, but this should not be construed as limiting. If all that is required is conductivity, the terminal electrode 510 may be disposed on only one side surface.

To improve the reliability of the electrical connection and reduce battery resistance, the terminal electrodes 510 may be disposed on three side surfaces, four side surfaces, or the entire outer periphery of the battery.

The terminal electrode 510 is formed of a conductive material. The terminal electrode 510 is formed, for example, by applying a conducting paste containing highly conductive metal particles, such as silver and copper, which is then dried and hardened.

The conducting paste may be applied by a common technique such as screen printing.

The terminal electrode 510 may have a thickness of greater than or equal to 10 μm and less than or equal to 100 μm in view of conductivity. This configuration can provide a compact series-connected assembled battery having high reliability.

### Method of Producing Battery

The following describes an example of a method of producing a battery according to the present disclosure. Here, a method of producing the battery 1200 according to the third embodiment will be described as an example.

In the following description, the first electrode layer is a positive electrode, and the second electrode layer is a negative electrode.

First, printing pastes for forming the positive electrode active material layer and the negative electrode active material layer are prepared. For example, Li₂S—P₂S₅ glass powder, which has an average particle size of about 3 μm and is mainly composed of triclinic crystals, is provided as a solid electrolyte raw material that forms composite materials for the positive electrode active material layer and the negative electrode active material layer. The glass powder has ion conductivity of, for example, 2×10⁻³ S/cm to 5×10⁻³ S/cm.

The positive electrode active material may be a powder of layered Li—Ni—Co—Al composite oxide (e.g., LiNi_{0.8}Co_{0.15}Al_{0.05}O₂) having an average particle size of about 3 μm.

A composite material including the above positive electrode active material and the above solid electrolyte powder is dispersed in an organic solvent or the like to produce a paste for the positive electrode active material layer by using a three-roll mill. The negative electrode active material may be a natural graphite powder having an average particle size of about 10 μm. A composite material forming the above negative electrode active material and the above solid electrolyte powder is dispersed in an organic solvent or the like to produce a paste for the negative electrode active material layer.

Next, copper foils having a thickness of about 15 μm are provided as the positive current collector and the negative current collector. By a screen-printing method, the pastes for the positive electrode active material layer and the negative electrode active material layer are printed on one surface (or two surfaces) of the copper foils in a predetermined shape and at a thickness of about 50 μm to about 100 μm. The pastes for the positive electrode active material layer and the negative electrode active material layer are dried at 80° ° C. to 130° C. In this way, the positive electrode active material layer is formed on the positive electrode current collector, and the negative electrode active material layer is formed on the negative electrode current collector. Thus, a positive electrode layer and a negative electrode layer are produced. The positive electrode layer and the negative electrode layer each have a thickness of 30 μm to 60 μm.

Next, a paste for the solid electrolyte layer dispersed in an organic solvent or the like is produced. On the positive electrode and the negative electrode, the paste for the solid electrolyte layer is printed at a thickness of, for example, about 100 μm using a metal mask. Then, the positive electrode and the negative electrode each having the printed paste for the solid electrolyte layer are dried at 80° C. to 130° ° C.

Next, for example, side surfaces of the solid electrolyte layer are partly removed by laser machining so that the positive and negative electrode current collectors are partly exposed at the side surfaces. For example, a cut may be made by a cutter or other means in the side surfaces, and the side surfaces may be partly peeled off. Then, a paste for the solid electrolyte layer (second solid electrolyte layer) is printed on the surface of the negative electrode current collector opposite from the surface having the negative electrode active material layer, using a metal mask, and dried.

Then, the solid electrolyte printed on the positive electrode active material layer and the solid electrolyte printed on the negative electrode active material layer are opposed to each other and made in contact with each other to form a laminated body, and the laminated body is placed in a die mold having a rectangular outer shape.

Next, an elastic sheet having a thickness of 70 μm and an elastic modulus of about 5×10⁶ Pa is placed between a pressure die punch and the laminated body. Then, the pressure die heated to 50° C. applies a pressure of 300 MPa to the laminated body for 90 seconds. In this way, the laminate including the positive electrode, the first solid electrolyte layer, the negative electrode, and the second solid electrolyte layer is produced.

In order to make the second solid electrolyte layer softer than the first solid electrolyte layer, for example, the amount of the binder resin component included in the second solid electrolyte layer may be increased to increase the voids, a soft component such as BBP and DBP that imparts plasticity may be added, or the content of the soft component may be adjusted. The softness of the solid electrolyte layer can be controlled in this way. The softness of the solid electrolyte layer can also be controlled by varying the mixing ratio of the solid electrolyte materials having different hardness. For example, in general, sulfide-based materials and amorphous materials are softer, and oxide-based materials are harder. The mixing ratio of these materials may be adjusted to control the softness of the solid electrolyte layer. Of the sulfide-based materials, one having an argillodite structure is hard, and LPSs are soft, for example. The softness of the solid electrolyte layer is adjusted by these materials having different hardness.

The hardness comparison between the first solid electrolyte layer and the second solid electrolyte layer is made by using a rigid indenter like one used in the Vickers hardness test. The indenter is pressed against the cross-sectional surfaces, and the relative hardness, soft or hard, is determined by the amount of deformation, large or small. In the Vickers hardness test, large deformation means soft, and small deformation means hard.

Next, a thermosetting epoxy conductive resin containing Ag particles is applied to both end faces and cured at 100 to 150° C. to form the terminal electrodes.

In this way, the battery 1200 is produced.

The method of producing the battery and the order of steps should not be limited to the described example.

In the described method, the paste for the positive electrode active material layer, the paste for the negative electrode active material layer, and the printing paste for the solid electrolyte layer are applied by printing, but this should not be construed as limiting. Other examples of the application method include a doctor blade method, a calendar method, a spin coating method, a dip coating method, an inkjet method, an offset method, a die coating method, and a spray method.

The batteries according to the present disclosure were described above with reference to the embodiments, but the present disclosure should not be limited to the embodiments. Without departing from the gist of the present disclosure, various changes may be made to the embodiments by a person skilled in the art, and the components in different embodiments may be combined. They are construed as being within the scope of the present disclosure.

### INDUSTRIAL APPLICABILITY

The batteries according to the present disclosure can be used as secondary batteries such as all-solid-state lithium-ion batteries installed in various electrical devices or automobiles.

What is claimed is:

1. A battery comprising
a first electrode layer,
a first solid electrolyte layer,
a second electrode layer, and
a stress relaxation layer in this order, wherein
the first solid electrolyte layer contains a first solid electrolyte material,
the stress relaxation layer satisfies at least one selected from the group consisting of (A) and (B):
(A) the stress relaxation layer is thicker than the first solid electrolyte layer; and
(B) the stress relaxation layer is softer than the first solid electrolyte layer, and
the stress relaxation layer is substantially non-electron conductive.

2. The battery according to claim 1, wherein
the stress relaxation layer is formed of a stress relaxation material, and
the stress relaxation material satisfies at least one selected from the group consisting of (C) and (D):
(C) difference in thermal shrinkage between the stress relaxation material and the first solid electrolyte material when heated at 200° C./h from room temperature to 800° C., held at 800° ° C. for 2 hours, and cooled at 200° C./h to room temperature is greater than or equal to −15% and less than or equal to 15%; and
(D) difference in compressibility between the stress relaxation material and the first solid electrolyte material when pressurized at a pressure of 300 MPa at 50° C. for 90 seconds is greater than or equal to −15% and less than or equal to 15%.

3. The battery according to claim 1, wherein the stress relaxation layer contains a second solid electrolyte material and satisfies (A).

4. The battery according to claim 3, wherein
the second solid electrolyte material satisfies at least one selected from the group consisting of (E) and (F):
(E) difference in thermal shrinkage between the second solid electrolyte material and the first solid electrolyte material when heated at 200° C./h from room temperature to 800° C., held at 800° C. for 2 hours, and cooled at 200° C./h to room temperature is greater than or equal to −15% and less than or equal to 15%; and
(F) difference in compressibility between the second solid electrolyte material and the first solid electrolyte material when pressurized at a pressure of 300 MPa at 50° C. for 90 seconds is greater than or equal to −15% and less than or equal to 15%.

5. The battery according to claim 3, wherein the second solid electrolyte material has a same composition as the first solid electrolyte material.

6. The battery according to claim 3, wherein the second solid electrolyte material has a composition different from that of the first solid electrolyte material.

7. The battery according to claim 1, wherein the stress relaxation layer is at least twice as thick as the first solid electrolyte layer.

8. The battery according to claim 1, wherein the stress relaxation layer has a thickness greater than a total thickness of the first electrode layer, the first solid electrolyte layer, and the second electrode layer.

9. The battery according to claim 1, wherein the stress relaxation layer has a lower density than the first solid electrolyte layer.

10. The battery according to claim 1, wherein the second electrode layer curves convexly toward the stress relaxation layer.

11. The battery according to claim 1, further comprising a third electrode layer, wherein
the stress relaxation layer is located between the second electrode layer and the third electrode layer.

12. The battery according to claim 11, wherein the third electrode layer curves convexly in the same direction as the second electrode layer, and
the second electrode layer curves more than the third electrode layer.

13. The battery according to claim 11, wherein the third electrode layer is electrically coupled to the second electrode layer.

14. The battery according to claim 11, wherein the third electrode layer is electrically coupled to the first electrode layer.

15. The battery according to claim 11, further comprising a second solid electrolyte layer, wherein
the third electrode layer is located between the stress relaxation layer and the second solid electrolyte layer.

16. The battery according to claim 15, wherein the stress relaxation layer is thicker than the first solid electrolyte layer and the second solid electrolyte layer.

17. The battery according to claim 15, wherein the stress relaxation layer is at least twice as thick as the second solid electrolyte layer.

18. The battery according to claim 15, further comprising a fourth electrode layer, wherein
the second solid electrolyte layer is located between the third electrode layer and the fourth electrode layer.

19. The battery according to claim 18, wherein the stress relaxation layer has a thickness greater than a total thickness of the third electrode layer, the second solid electrolyte layer, and the fourth electrode layer.

20. The battery according to claim 15, wherein the stress relaxation layer contains a second solid electrolyte material,
the second solid electrolyte layer contains a third solid electrolyte material, and
the second solid electrolyte material has a same composition as the third solid electrolyte material.

21. The battery according to claim 15, wherein the stress relaxation layer has a lower density than the second solid electrolyte layer.
